(19) United States
(12) Patent Application Publication
(10) Pub. No.: US 2008/0163842 A1
(43) Pub. Date: Jul. 10, 2008

(54) Starter Arrangement for an Internal Combustion Engine

(76) Inventors: Jonas Forssell, Torslanda (SE); Peter Ulrik Gast, Torslanda (SE); Lars Johan Stenvall, Ljungskile (SE); Petter Almhagen, Floda (SE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/862,216

(22) Filed: Sep. 27, 2007

(30) Foreign Application Priority Data
Sep. 29, 2006 (EP) 06121537.2

(51) Int. Cl. F02N 15/08; F02N 11/00; F01M 9/12; F02F 11/00

(52) U.S. Cl. 123/179.25; 74/7 C; 123/196 R; 277/500

(57) ABSTRACT

The present invention relates to a starter arrangement for an internal combustion engine. The starter arrangement has a starter motor (1) having a pinion gear (2) at an output shaft. The pinion gear (2) is arranged in constant engagement with a corresponding crank gear of a crank wheel (3) located between an engine block (4) and a flywheel (11) of the engine. The crank wheel (3) is operatively connected to a crankshaft of the engine via a one-way clutch (6). The one-way clutch (6) is arranged at an engine block (4) side of a crankshaft oil seal (7) enabling lubrication and cooling thereof by an engine oil of the engine.

### TECHNICAL FIELD

The present invention is related to a starter arrangement for an internal combustion engine adapted to facilitate start-stop operation.

### BACKGROUND OF THE INVENTION

A start-stop or idle-stop operating mode is based on the concept of halting a vehicle combustion engine during vehicle standstill, e.g. when waiting for a traffic light to change from red to green. Such an arrangement may allow for substantial savings in fuel consumption. For mixed highway/rural and city driving savings of at least 2-4% are feasible and for city driving savings of up to 10% are feasible.

Some previous attempts to provide such arrangements have been based on belt drives or have been starter based. Starter-based systems are low cost and scalable to all sizes and kinds of powertrains but have two major drawbacks. They cannot be engaged during engine ramp down (driver regret) and they are quite noisy due to engagement noise and cranking noise.

One previous attempt at addressing the above problems with starter based systems is provided by JP 2002 74337, which describes a starting device for a vehicle, such as an idle stop car or a hybrid car, which starting device is especially suited for noise reduction. The starting device is provided with a pinion gear on the output shaft of an electric motor. A ring gear is engaged and always meshes with the pinion gear. Between the ring gear and a crankshaft is arranged a one-way clutch which intervenes between the ring gear and the crankshaft, and which is arranged to permit only the transmission of driving force from the side of the electric motor to the internal combustion engine for starting thereof. The one-way clutch is built in between the ring gear and a flywheel of the internal combustion engine. To reduce the noise generated, it is proposed to raise the dental rate of engagement and engagement precision, which is enabled through the ring gear being engaged and always meshing with the pinion gear.

Although JP 2002 74337 addresses the noise and engagement problems by the ring gear engaging and always meshing with the pinion gear a new problem is introduced. As the internal combustion engine of an idle stop vehicle or a hybrid vehicle will be brought to start automatically, e.g. by an onboard computer, the number of starts and stops will be quite considerable, especially during city driving. This is likely to put considerable strain on the one-way clutch of the starter arrangement.

### SUMMARY OF THE INVENTION

In the present invention an improved starter arrangement for an internal combustion engine the arrangement comprising a starter motor having a pinion gear at an output shaft is provided. The pinion gear is arranged in constant engagement with a corresponding crank gear of a crank wheel located between an engine block and a flywheel of the engine. The crank wheel is operatively connected to a crankshaft of the engine via a one-way clutch.

According to an aspect of the present invention, the one-way clutch is arranged at an engine block side of a crankshaft oil seal enabling lubrication and cooling thereof by engine oil, whereby the thermal and mechanical strain on the one-way clutch will be reduced providing cooling and lubrication of the one-way clutch. An advantage of such an arrangement is that the life of the one-way clutch is increased.

Because the pinion gear is arranged in constant engagement with the corresponding crank gear of the crank wheel located between an engine block and a flywheel of the engine via a one-way clutch, strain on the starter arrangement is reduced, thereby prolonging its life.

According to another aspect of the present invention, the one-way clutch is arranged at an engine block side of a crankshaft oil seal enabling lubrication and cooling thereof by engine oil. Consequently, the thermal and mechanical strain on the one-way clutch is reduced by the provided lubrication and cooling of the one-way clutch.

It will be appreciated that features of the invention are susceptible to being combined in any combination without departing from the scope of the invention as defined by the accompanying claims.

### BRIEF DESCRIPTION OF THE DRAWINGS

By way of example only, embodiments of the present invention will now be described with reference to the accompanying drawings wherein:

FIG. 1 is a schematic view of a starter arrangement according to the present invention;

FIG. 2 is a schematic partial section through a lower half of the starter arrangement according to FIG. 1; and

FIG. 3 shows in more detail the one-way clutch of FIG. 2 and an associated flow of engine oil for lubrication and cooling thereof.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. The same reference numerals will be used for illustrating corresponding features in the different drawings.

### DETAILED DESCRIPTION

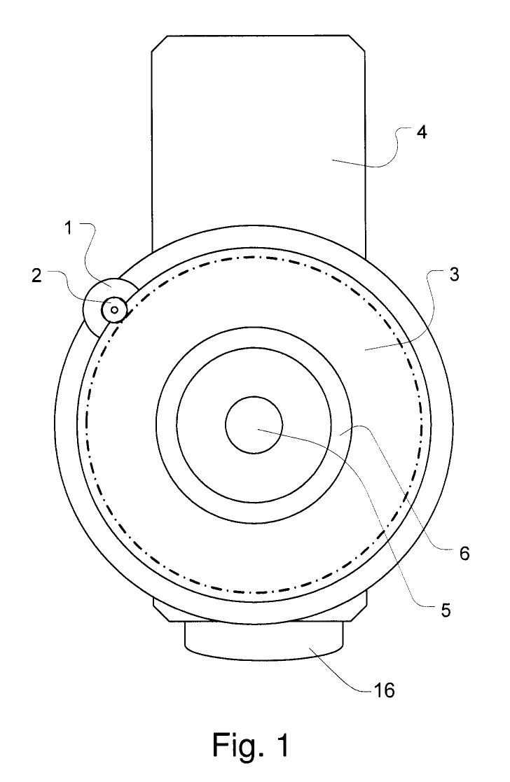

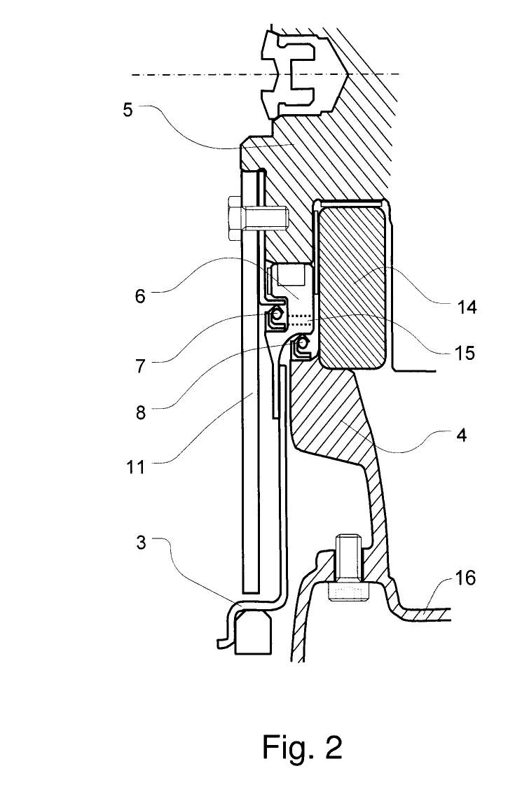

In one embodiment of the present invention shown schematically in FIG. 1, a starter arrangement for an internal combustion engine is shown. The starter arrangement comprises a starter motor 1, e.g. an electric starter motor, having a pinion gear 2 at an output shaft. The pinion gear 2 is arranged in constant engagement with a corresponding crank gear of a crank wheel 3 located between an engine block 4 and a flywheel 11 (as shown from a different perspective in FIG. 2) of the engine.

As shown in FIG. 2, crank wheel 3 is connected to a crankshaft 5 of the engine via a one-way clutch 6. The one-way clutch 6 is arranged at an engine block 4 side of a crankshaft oil seal 7 enabling lubrication and cooling thereof by engine oil.

In one embodiment, crank wheel 3 is a ring gear arranged to rotate with starter 1 during starting. Crank wheel 3 freewheels when the engine overruns starter 1. The one-way clutch 6 engages during starting and disengages during engine operation. Preferably, starter 1 is permanently engaged to ring gear 3 facilitating the design of the meshing gears between the two parts to be refined and optimized for generating a minimum of noise during operation. One-way clutch 6 is arranged at the center of crank wheel 3. The crankcase of the engine is sealed by crankshaft oil seal 7, which is arranged between one-way clutch 6 and crankshaft 5.

Continuing with FIG. 2, a second oil seal 8 is arranged on the one-way clutch 6. The one way clutch is proximate to the oil pan 16 at the lower end of the engine and proximate to the block 4 at the upper end of the engine (n be seen in FIG. 1.) Thus, second oil seal 8 seals between one-way clutch 6 and block 4 for a portion of the sealing surface and between one-way clutch 6 and oil pan 16 for another portion of the sealing surface. Engine oil access is restricted to lubricate and cool one-way clutch 6 without entering an associated clutch/converter housing (not shown).

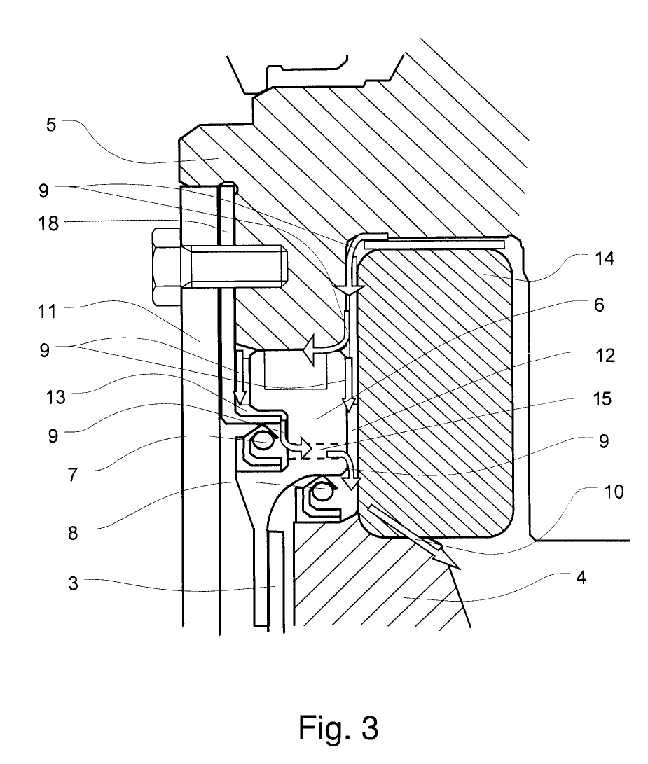

To promote lubrication and cooling, the one-way clutch 6 preferably comprises passages for allowing a flow of engine oil, illustrated by the arrows 9 in FIG. 3, through the one-way clutch 6. There is at least one passage 15, such as a hole or a slot, through which engine oil may be circulated for lubrication and cooling of one-way clutch 6. This engine oil is drained (illustrated by arrow 10) to an oil pan 16 (shown in FIG. 2) of the engine through appropriate drainage channels (not shown) provided through the crankshaft bearing 14 and/or the block 4. Plate 18 is placed in between crankshaft 5 and flywheel 11. Plate 18 has a substantially perpendicular bend at its periphery which is provided as a sealing surface for oil seal 7.

In a preferred embodiment to further promote the lubrication and cooling of one-way clutch 6, passages 12 and 13 are provided between one-way clutch 6 and adjacent components, such as a crankshaft bearing cap 14, such that engine oil is allowed to flow around the one-way clutch 6 with passage 12 being across a face of one-way clutch facing crankshaft bearing cap 14 and passage 13 being across the opposite face.

Furthermore, in accordance with the present invention is also envisaged a method for reducing strain on a starter arrangement for an internal combustion engine. The starter arrangement comprises a starter motor 1 having a pinion gear 2 at an output shaft. The pinion gear 2 of the starter motor is arranged in constant engagement with a corresponding crank gear of a crank wheel 3 located between an engine block 4 and a flywheel 11 of the engine. Furthermore, the crank wheel 3 is operatively connected to a crankshaft 5 of the engine via one-way clutch 6. The method in accordance with the present invention comprises the step of arranging the one-way clutch 6 at an engine block 4 side of a crankshaft oil seal 7. Through this step lubrication and cooling of the one-way clutch 6 by an engine oil of the engine is provided.

Modifications to embodiments of the invention described in the foregoing are possible without departing from the scope of the invention as defined by the accompanying claims.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A starter arrangement for an internal combustion engine having a crankshaft (5), comprising:
a one-way clutch (6) mounted on the periphery of an end of the crankshaft (5), said one-way clutch (6) being in communication with engine lubricating oil;
a crank wheel (3) fixed to said one-way clutch (6), said crank wheel (3) having gear teeth at its periphery; and
a starter motor (1) having a pinion gear (2) engaged with said gear teeth.

2. The starter arrangement of claim 1 wherein said pinion gear (2) is in constant engagement with said gear teeth of said crank wheel (3).

3. The starter arrangement of claim 1 wherein a supply of pressurized engine lubricating oil is provided to the crankshaft (5) to lubricate crankshaft bearings and said one-way clutch (6) is supplied engine lubricating oil leaving said crankshaft bearing (14).

4. The starter arrangement of claim 1, further comprising:
an oil seal mounted (8) on the periphery of said one-way clutch (6).

5. The starter arrangement of claim 4 wherein said oil seal (8) is located between said one-way clutch (6) and a block (4) of said engine.

6. The starter arrangement of claim 1, further comprising:
a flywheel (11) coupled to the crankshaft (5);
a plate (18) mounted between the crankshaft (5) and said flywheel (11), said plate (18) being bent substantially perpendicular at a periphery of said plate (18); and
an oil seal (7) mounted between said bent end of said plate and said one-way clutch.

7. The starter arrangement of claim 1, wherein the engine has an engine block (4), further comprising:
a crankshaft main bearing cap (14) mounted to said block (4) in which the crankshaft (5) is held; and
an oil passage (13) on a side of said one-way clutch (6), said side facing away from said crankshaft main bearing cap (14), said passage (13) conducting oil toward the periphery of said one-way clutch (6).

8. The starter arrangement of claim 1, wherein the engine has an engine block (4), further comprising:
A crankshaft main bearing cap (14) mounted to said block (4) in which the crankshaft is held; and
an oil passage (12) on a side of said one-way clutch (6), said side facing toward said crankshaft main bearing cap (14), said oil passage (12) conducting oil toward the periphery of said one-way clutch (6).

9. The starter arrangement of claim 1, further comprising:
a passage (15) through said one-way clutch (6).

10. The starter arrangement of claim 1, further comprising:
a first oil passage (15) through said one-way clutch (6);
a second oil passage (13) on a first side of said one-way clutch, said first side facing toward said main bearing cap (14), said oil passage (13) conducting oil toward the periphery of said one-way clutch (6); and
a third oil passage (12) on a second side of said one-way clutch facing, said second side facing toward said main bearing cap (14), said second oil passage (12) conducting oil toward the periphery of said one-way clutch (6) wherein said passage (15) is arranged to conduct oil from said first oil passage (13) to said second oil passage (12).

11. A starter arrangement for an internal combustion engine, comprising:
an engine block (4) having a crankshaft (5);
a flywheel of the engine coupled to said crankshaft (5);
a crank wheel (3) having gear teeth at its periphery, said crank wheel being located between said engine block (4) and said flywheel (11);
a one-way clutch (6) disposed between said crank wheel (3) and said crankshaft (5);
a starter motor (1) having a pinion gear (2) at an output shaft of said starter motor (1), said pinion gear (2) being engaged with said crank wheel (3); and
a crankshaft oil seal (7) arranged on said one-way clutch (6) such that said one-way clutch is provided engine lubricating oil.

12. The starter arrangement of claim 11 wherein one-way clutch (6) further comprises an oil passage (15) for allowing flow of engine oil through said one-way clutch (6).

13. The starter arrangement of claim 12 wherein said oil passage (15) is one of a slot and a hole.

14. The starter arrangement of claim 12 wherein said oil passage (15) allows oil flow from a flywheel (11) side to an engine block (4) side of said one-way clutch (6).

15. The starter arrangement of claim 11, further comprising:
first and second oil passages (12, 13) adjacent to said one-way clutch (6) to provide flow around said one-way clutch (6).

16. A starter arrangement for an internal combustion engine having a crankshaft (5), comprising:
a one-way clutch (6) mounted on the periphery of an end of the crankshaft (5), said one-way clutch (6) being supplied engine lubricating oil from a crankshaft bearing cap (14) of the engine;
an oil seal (8) mounted on the periphery of said one-way clutch (6), said oil seal (8) providing a seal between said one-way clutch (6) and a block (4) of the engine;
a crank wheel (3) fixed to said one-way clutch (6), said crank wheel (3) having gear teeth at its periphery; and
a starter motor (1) having a pinion gear (2) in constant engagement with said gear teeth of said crank wheel (3).

17. The starter arrangement of claim 16, further comprising:
a flywheel (11) coupled to the crankshaft (5), said flywheel having a smooth periphery.

18. The starter arrangement of claim 17 wherein said one-way clutch (6) is disposed between said engine block (4) and said flywheel (11).

19. The starter arrangement of claim 16, further comprising an oil passage (15) through said one-way clutch (6).
